(19) United States
(12) Patent Application Publication
(10) Pub. No.: US 2021/0314385 A1
(43) Pub. Date: Oct. 7, 2021

(54) INTEGRATION OF HYPER CONVERGED INFRASTRUCTURE MANAGEMENT WITH A SOFTWARE DEFINED NETWORK CONTROL

(71) Applicant: Cisco Technology, Inc., San Jose, CA (US)

(72) Inventors: Vinay Jayant Pande, San Jose, CA (US); Eric Dale Williams, Champaign, IL (US); Abdallah Othman Abdallah Mashargah, Santa Clara, CA (US)

(21) Appl. No.: 16/842,392

(22) Filed: Apr. 7, 2020

(51) Int. Cl. H04L 29/08

(52) U.S. Cl. CPC H04L 67/02; H04L 69/329

(57) ABSTRACT

Systems, methods, and computer-readable for integrating a Hyper Converged Infrastructure (HCI) management platform with a Software Defined Wide Area Network (SDWAN) controller at a network site connected to a Software Defined Wide Area Network (SDWAN) through one or more edge devices include receiving an indication associated with a Hyper Converged Application at a the HCI management platform. The indication may be based on an availability of the Hyper Converged Application at the network site. Based on resources available at the network site, the HCI management platform or the SDWAN controller can determine whether the Hyper Converged Application can be shared with one or more network devices connected to the SDWAN, and the Hyper Converged Application can be advertised as being available for sharing with the one or more network devices if it is determined that the Hyper Converged Application can be shared with the one or more network devices.

### TECHNICAL FIELD

The subject matter of this disclosure relates in general to the field of computer networking, and more particularly to integration of application chaining with hyper converged infrastructure (HCI) management platform integrated with a software-defined wide area network (SDWAN) controller.

### BACKGROUND

The enterprise network landscape is continuously evolving. There is a greater demand for mobile and Internet of Things (IoT) device traffic, Software as a Service (SaaS) applications, and cloud adoption. In recent years, software-defined enterprise network solutions have been developed to address the needs of enterprise networks. Software-defined enterprise networking is part of a broader technology of software-defined networking (SDN) that includes both software-defined wide area networks (SDWAN) and software-defined local area networks (SDLAN). SDN is a centralized approach to network management which can abstract away the underlying network infrastructure from its applications. This de-coupling of data plane forwarding and control plane can allow a network operator to centralize the intelligence of the network and provide for more network automation, operations simplification, and centralized provisioning, monitoring, and troubleshooting.

Edge devices include network devices configured at a periphery of an SDN fabric, for connecting a local site to the network fabric, for example. The local sites can include Remote Office/Branch Office (ROBO), data centers, branch sites, etc. There are ever increasing demands on the compute resources at the edge devices due to rapidly increasing amount of data traffic handled at the edge devices. There is also an increasing demand for deploying enterprise specific custom applications at local sites or ROBO locations, along with use case specific applications such as Machine Learning, Retail, Video Analytics, IoT, and others at the local sites. To meet these and other demands, Hyper Converged Infrastructure (HCI) is fast emerging as a popular solution for edge devices, given the ability for HCI to offer management simplicity and performance for computing and storage. Examples of HCIs include Cisco's HyperFlex and a variant called HyperFlex Edge, which is optimized for ROBO deployments.

As previously mentioned, SDNs or more specifically, software defined wide area networks (SDWANs) offer a wide range of software-defined overlay capabilities for connecting various sites, providing agility to WAN management, and enabling new types of connectivity models beyond traditional virtual private networks (VPNs).

However, in existing implementations, HCI and SDWAN are deployed to operate as independent solutions. For example, the HCI and SDWAN deployments may have separate controllers (e.g., separate cloud-based controllers). While SDWAN solutions allow a network administrator to identify applications at the different sites for routing over the SDWAN (referred to as application visibility), define path controls for identified applications, set policies and thresholds for routing these applications based on WAN link characteristics, etc., these are currently performed as manual processes. For example, an administrator may manually enable application visibility, set policies for each application type identified, classify an application each time the application is visible on the SDWAN, ensure that the classification is correct in terms of Quality of Service (QoS), priority, and other metrics, routed over the correct WAN links with designated thresholds, etc. The platforms for automation and management offered by the HCI at the edge devices is not leveraged by the SDWAN solutions. On the other hand, the computational resources, visibility, and management capabilities of the SDWAN controllers are also not exploited by the HCIs at the edge devices.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a topology of an enterprise network in accordance with some examples;

FIG. 2 illustrates a software defined network architecture in accordance with some examples;

FIG. 3 illustrates aspects of application aware overlay routing in a software defined network, in accordance with some examples;

FIG. 4 illustrates a system implementing a hyper converged infrastructure (HCI) management platform implemented at a network site, in accordance with some examples;

FIG. 5 illustrates a system implementing a hyper converged infrastructure (HCI) management platform integrated with an SDWAN controller, in accordance with some examples;

FIG. 6 illustrates a process for application chaining in a network site implementing a hyper converged infrastructure (HCI) management platform integrated with an SDWAN controller, in accordance with some examples;

FIG. 7 illustrates an example network device in accordance with some examples; and

FIG. 8 illustrates an example computing device architecture, in accordance with some examples.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed herein are systems, methods, and computer-readable media for integrating a Hyper Converged Infrastructure (HCI) management platform with a Software Defined Wide Area Network (SDWAN) controller at a network site connected to the SDWAN through one or more edge devices. An indication associated with a Hyper Converged Application can be received at a the HCI management platform. The indication may be based on an availability of the Hyper Converged Application at the network site. Based on resources available at the network site, the HCI management platform or the SDWAN controller can determine whether the Hyper Converged Application can be shared with one or more network devices connected to the SDWAN, and the Hyper Converged Application can be advertised as being available for sharing with the one or more network devices if it is determined that the Hyper Converged Application can be shared with the one or more network devices.

In some examples, policy settings for the Hyper Converged Application can be obtained from the SDWAN controller. For example, the indication may be received from a Hyper Converged Application controller of the network site based on the Hyper Converged Application being instantiated at the network site, along with receiving one or more parameters related to the Hyper Converged Application from the Hyper Converged Application controller, the one or more parameters comprising one or more of an expected delay, latency, or Quality of Service (QoS) settings related to the Hyper Converged Application. A request for policy settings for the Hyper Converged Application, the one or more parameters, and one or more recommendations for policy settings for the Hyper Converged Application can be communicated to the SDWAN controller. Policy settings may be received in response to the request, based on the request being accepted by the controller of the SDWAN, and the policy settings may be provided to the Hyper Converged Application controller for the policy settings to be applied to the Hyper Converged Application.

In some examples, a method is provided. The method includes receiving an indication associated with a Hyper Converged Application at a Hyper Converged Infrastructure (HCI) management platform, the HCI management platform deployed at a network site connected to a Software Defined Wide Area Network (SDWAN) through one or more edge devices, the indication being based on an availability of the Hyper Converged Application at the network site; determining, based on resources available at the network site, whether the Hyper Converged Application can be shared with one or more network devices connected to the SDWAN; and advertising the Hyper Converged Application as being available for sharing with the one or more network devices based on coordinating with a controller of the SDWAN if it is determined that the Hyper Converged Application can be shared with the one or more network devices

In some examples, a system is provided. The system, comprises one or more processors; and a non-transitory computer-readable storage medium containing instructions which, when executed on the one or more processors, cause the one or more processors to perform operations including: receiving an indication associated with a Hyper Converged Application at a Hyper Converged Infrastructure (HCI) management platform, the HCI management platform deployed at a network site connected to a Software Defined Wide Area Network (SDWAN) through one or more edge devices, the indication being based on an availability of the Hyper Converged Application at the network site; determining, based on resources available at the network site whether the Hyper Converged Application can be shared with one or more network devices connected to the SDWAN; and advertising the Hyper Converged Application as being available for sharing with the one or more network devices based on coordinating with a controller of the SDWAN if it is determined that the Hyper Converged Application can be shared with the one or more network devices.

In some examples, a non-transitory machine-readable storage medium is provided, including instructions configured to cause a data processing apparatus to perform operations including: receiving an indication associated with a Hyper Converged Application at a Hyper Converged Infrastructure (HCI) management platform, the HCI management platform deployed at a network site connected to a Software Defined Wide Area Network (SDWAN) through one or more edge devices, the indication being based on an availability of the Hyper Converged Application at the network site; determining, based on resources available at the network site whether the Hyper Converged Application can be shared with one or more network devices connected to the SDWAN; and advertising the Hyper Converged Application as being available for sharing with the one or more network devices based on coordinating with a controller of the SDWAN if it is determined that the Hyper Converged Application can be shared with the one or more network devices.

In some examples, the HCI management platform comprises a cloud based management platform for one or more of automated generation of switch configuration of resources at the network site, automated deployment of Virtual Network Functions (VNFs), or generation of status and telemetry pertaining to the SDWAN to be provided over one or more user interfaces.

In some examples, the Hyper Converged Application comprises one or more Layer 7 applications sharable over an application route of the SDWAN with the one or more network devices.

In some examples, determining whether the Hyper Converged Application can be shared with one or more network devices comprises comparing resources available at two or more network sites advertising the Hyper Converged Application.

In some examples, the indication comprises a Resource Availability Indicator (RAI) advertised by a Hyper Converged Application controller of the network site based on the Hyper Converged Application being instantiated at the network site, the RAI configured to identify the Hyper Converged Application and indicate whether the Hyper Converged Application is available and sharable with the one or more network devices connected to the SDWAN.

Some examples further comprise: receiving one or more parameters related to the Hyper Converged Application from the Hyper Converged Application controller, the one or more parameters comprising one or more of an expected delay, latency, or Quality of Service (QoS) settings related to the Hyper Converged Application.

Some examples further comprise: communicating a request for policy settings for the Hyper Converged Application, the one or more parameters, and one or more recommendations for policy settings for the Hyper Converged Application to a controller of the SDWAN.

Some examples further comprise: receiving policy settings in response to the request, based on the request being accepted by the controller of the SDWAN, and providing the policy settings to the Hyper Converged Application controller for the policy settings to be applied to the Hyper Converged Application.

This overview is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim. The foregoing, together with other features and embodiments, will become more apparent upon referring to the following specification, claims, and accompanying drawings

### DESCRIPTION OF EXAMPLE EMBODIMENTS

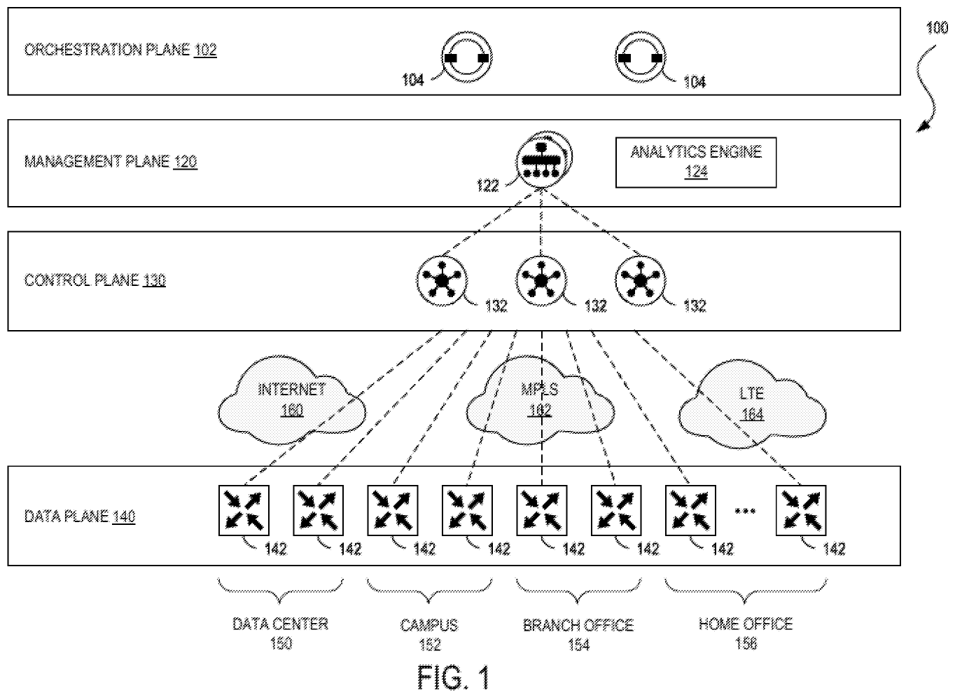

FIG. 1 illustrates an example of a network architecture 100 for implementing aspects of the present technology. An example of an implementation of the network architecture 100 is the Cisco® Software Defined Wide Area Network (SDWAN) architecture. In some examples, the network architecture 100 can correspond to an enterprise network. However, one of ordinary skill in the art will understand that, for the network architecture 100 and any other system discussed in the present disclosure, there can be additional or fewer component in similar or alternative configurations. The illustrations and examples provided in the present disclosure are for conciseness and clarity. Other examples may include different numbers and/or types of elements but one of ordinary skill the art will appreciate that such variations do not depart from the scope of the present disclosure.

In the illustrated example, the network architecture 100 includes an orchestration plane 102, a management plane 120, a control plane 130, and a data plane 140. The orchestration plane 102 can assist in the automatic on-boarding of edge network devices 142 (e.g., switches, routers, etc.) in an overlay network. The orchestration plane 102 can include one or more physical or virtual network orchestrator appliances 104. The network orchestrator appliance(s) 104 can perform the initial authentication of the edge network devices 142 and orchestrate connectivity between devices of the control plane 130 and the data plane 140. In some aspects, the network orchestrator appliance(s) 104 can also enable communication of devices located behind Network Address Translation (NAT). In some aspects, physical or virtual Cisco® SDWAN vBond appliances can operate as the network orchestrator appliance(s) 104.

The management plane 120 can be responsible for central configuration and monitoring of the network architecture 100. The management plane 120 can include one or more physical or virtual network management appliances 122. In some embodiments, the network management appliance(s) 122 can provide centralized management of the network via a graphical user interface to enable a user to monitor, configure, and maintain the edge network devices 142 and one or more transport links between the edge network devices 142 and external networks (e.g., Internet 160, Multiprotocol Label Switching (MPLS) network 162, 4G/LTE network 164, etc.) in an underlay and overlay network. The network management appliance(s) 122 can support multi-tenancy and enable centralized management of logically isolated networks associated with different entities (e.g., enterprises, divisions within enterprises, groups within divisions, etc.). Alternatively or in addition, the network management appliance(s) 122 can be a dedicated network management system for a single entity. In some embodiments, physical or virtual Cisco® SDWAN vManage appliances can operate as the network management appliance(s) 122.

The control plane 130 can build and maintain a network topology and make decisions on where traffic flows. The control plane 130 can include one or more physical or virtual network controller appliance(s) 132. The network controller appliance(s) 132 can establish secure connections to each network device 142 and distribute route and policy information via a control plane protocol (e.g., Overlay Management Protocol (OMP), discussed in further detail below), Open Shortest Path First (OSPF), Intermediate System to Intermediate System (IS-IS), Border Gateway Protocol (BGP), Protocol-Independent Multicast (PIM), Internet Group Management Protocol (IGMP), Internet Control Message Protocol (ICMP), Address Resolution Protocol (ARP), Bidirectional Forwarding Detection (BFD), Link Aggregation Control Protocol (LACP), etc.). In some examples, the network controller appliance(s) 132 can operate as route reflectors. The network controller appliance(s) 132 can also orchestrate secure connectivity in the data plane 140 between and among the edge network devices 142. For example, in some embodiments, the network controller appliance(s) 132 can distribute crypto key information among the network device(s) 142. This can allow the network to support a secure network protocol or application (e.g., Internet Protocol Security (IPSec), Transport Layer Security (TLS), Secure Shell (SSH), etc.) without Internet Key Exchange (IKE) and enable scalability of the network. In some examples, physical or virtual Cisco® SDWAN vSmart controllers can operate as the network controller appliance(s) 132.

The data plane 140 can be responsible for forwarding packets based on decisions from the control plane 130. The data plane 140 can include the edge network devices 142, which can be physical or virtual network devices. In some examples, one or more of the edge network devices 142 can include edge routers configured for dynamic designation of primary and secondary edge router roles according to aspects described herein. The edge network devices 142 can operate at the edges various network environments of local networks such as an organization, e.g., in one or more data centers or colocation centers 150, campus networks 152, branch office networks 154, home office networks 154, and so forth, or in the cloud (e.g., Infrastructure as a Service (IaaS), Platform as a Service (PaaS), SaaS, and other cloud service provider networks). The edge network devices 142 can provide secure data plane connectivity among sites over one or more transport links. In some examples, the one or more transport links can include WAN transports to connect to external networks, such as the Internet 160 (e.g., Digital Subscriber Line (DSL), cable, etc.), MPLS networks 162 (or other private packet-switched network (e.g., Metro Ethernet, Frame Relay, Asynchronous Transfer Mode (ATM), etc.), mobile networks 164 (e.g., 3G, 4G/LTE, 5G, etc.), or other WAN technology (e.g., Synchronous Optical Networking (SONET), Synchronous Digital Hierarchy (SDH), Dense Wavelength Division Multiplexing (DWDM), or other fiber-optic technology; leased lines (e.g., T1/E1, T3/E3, etc.); Public Switched Telephone Network (PSTN), Integrated Services Digital Network (ISDN), or other private circuit-switched network; small aperture terminal (VSAT) or other satellite network; etc.). The edge network devices 142 can be responsible for traffic forwarding, security, encryption, quality of service (QoS), and routing (e.g., BGP, OSPF, etc.), among other tasks. In some embodiments, physical or virtual Cisco® SDWAN vEdge routers can operate as the edge network devices 142.

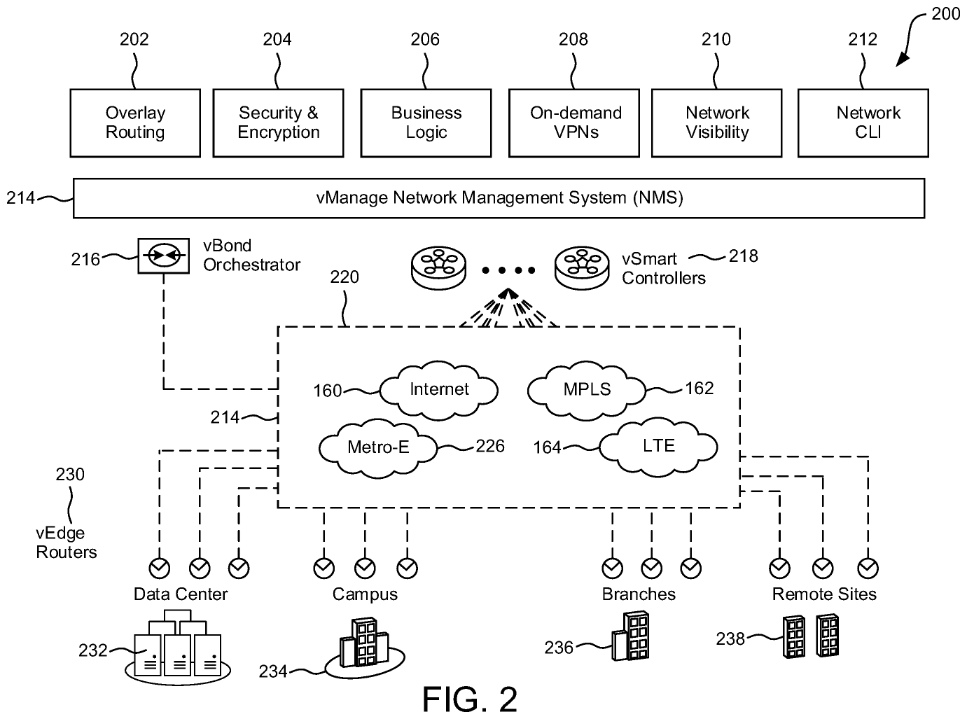

FIG. 2 illustrates an example of a network 200 configured according to example aspects. In some examples, the network 200 can be configured according to the network architecture 100. In some examples, the network 200 can implement an SDWAN network such as Cisco® SDWAN Secure Extensible Network (SEN). The SDWAN SEN can support WAN solutions for emerging enterprise networks, with a separation of the data plane from the control plane as described with reference to FIG. 1. The network 200 can also include overlay fabric support for virtualizing substantial portions of routing which can replace dedicated hardware in legacy implementations. The following aspects of the Cisco® SDWAN Secure Extensible Network (SEN) mentioned with reference to FIG. 1 will be explained in further detail.

The network 200 can support various functions which are identified as functional blocks, including overlay routing 202, security and encryption 204, business logic 206, on-demand Virtual Private Networks (VPNs) 208, network visibility 210, network command-line interface (CLI) 212 or other Application Programming Interface (API), among others. The network functions can be implemented using the following systems or suitable variants: network management system (NMS) 214, network orchestrator 216, one or more network controllers 218, and one or more edge devices or routers 230.

An example of the network management system (NMS) 214 (or network management appliance(s) 122 of FIG. 1) is the Cisco® vManage Network Management System (NMS), which can be configured as a centralized network management system of the network 200. The NMS 214 can enable a user to configure and manage the entire overlay network or fabric of the network 200. In some examples, the NMS 214 can provide a graphical user interface (GUI) such as a dashboard.

An example of the network controller 218 (or network controller appliance(s) 132 of FIG. 1) includes the Cisco® vSmart Controller, which can be configured as a centralized controller of the SDWAN implemented by the network 200. The network controller 218 can control the flow of data traffic throughout the network 200. One or more network controllers 218 can operate in conjunction with the network orchestrator 216 to authenticate edge devices as they join the network 200 and to orchestrate connectivity among the edge devices.

An example of the network orchestrator 216 (or network orchestrator appliance(s) 104 of FIG. 1) includes the Cisco® vBond Orchestrator. The network orchestrator 218 can be configured to automatically orchestrate connectivity between various edge devices and the one or more network controllers 218. If any edge device or network controller is behind a NAT, the network orchestrator 216 can also serve as an initial NAT-traversal orchestrator.

An example of the one or more edge devices 230 (or the edge network devices 142 of FIG. 1) includes the Cisco® vEdge Routers. The edge devices can be deployed at the perimeter of a local site such as a data center 232, campus 234, branch sites 236, remote sites 238, or other, to provide connectivity among the various sites. The edge devices 230 can be implemented using a suitable combination of hardware and/or software (e.g., a vEdge Cloud router can be implemented as a virtual machine). The edge devices 230 can handle the transmission of data traffic on the network 200.

The data traffic can be transported on the transport network 220 using a suitable combination of underlay and overlay networks The transport network 220 generally depicts various network options such as the Internet 160, MPLS 162, LTE 164, metro-E 226, etc. The transport network 220 can include various transport links which can be formed on the various network options to connect the edge devices 230 on the data plane and the devices on the control plane (e.g., network controllers 218), the management plane (e.g., NMS 214), and/or the orchestration plane (e.g., network orchestrator 216).

An overlay network management protocol such as the Cisco® SDWAN Overlay Management Protocol (OMP) can be used for overlay routing, establishing, and maintaining the SDWAN control plane. The overlay network management protocol can perform orchestration of overlay network communication, including connectivity among network sites, service chaining, and VPN topologies. In some examples, the overlay network management protocol can provide distribution of service-level routing information and related location mappings, distribution of data plane security parameters, central control and distribution of routing policy, among other services.

In some examples, the overlay network management protocol can include control protocols for exchange routing, policy, and management information between the network controllers 218 (e.g., the vSmart controllers) and the edge devices 230 (e.g., the vEdge routers) in the overlay network. These network devices such as the controllers, routers, etc., can automatically initiate overlay peering sessions between themselves. The end points of an overlay peering session can include system IP addresses of the devices involved in the peering session. Overlay management protocols can be used for information management and distribution protocol that enable the overlay networks by separating services from the transport network, for example.

In traditional VPN settings, the services provided may be located within a VPN domain, and so the services may be protected from being visible outside the VPN domain. In such traditional implementations, extending the VPN domains and service connectivity is a challenge. Overlay management protocols can address these challenges by providing an efficient way to manage service traffic based on the location of logical transport end points. For example, the data plane and control plane separation concept from within routers can be extended across the transport network, where the overlay management protocol may distribute control plane information, along with related policies. A central network controller 218 (e.g., the vSmart controller) can determine routing and access policies for the overlay routing domain. The overlay management protocol can be used to propagate routing, security, services, and policies that are used by edge devices for data plane connectivity and transport.

In some examples, the overlay management protocol can advertise routes and services to peers such as the network controllers and edge devices, where the routes and services may be learned from a local site, along with their corresponding transport location mappings (referred to as TLOCs in some implementations). These routes can be control routes which are referred to as OMP routes or vRoutes in some implementations, to distinguish them from standard IP routes. The routes advertised can include a tuple which includes the route and the TLOC associated with that route. The network controllers can learn the topology of the overlay network and the services available in the network using the OMP routes.

In some examples, the overlay management protocols can interact with traditional routing at local sites in the overlay network. For example, the overlay management protocols can import internal routing information from traditional routing protocols, such as Open Shortest Path First (OSPF) and Border Gateway Protocol (BGP), and this internal routing information can provide reachability within the local site. The importing of internal routing information from traditional routing protocols can be based on user-defined policies. Since overlay management protocols may operates in an overlay networking environment, the notion of routing peers is different from a traditional network environment. From a logical point of view, the overlay environment can include the centralized controller and a number of edge devices, where each edge device may advertise their internal routing information which has been imported to the centralized controller, and, based on policy decisions, the centralized controller can distribute the overlay routing information to other edge devices in the network. In such implementations, the edge devices may not advertise routing information to each other directly, but rely on the OMP peering between the centralized controller and the edge devices to exchange control plane traffic. The OMP peering may be avoided for data traffic in traditional implementations. Registered edge devices automatically collect routes from directly connected networks, as well as static routes and routes learned from Interior Gateway Protocols (IGP). The edge devices can also be configured to collect routes learned from BGP and the overlay management protocol can perform path selection, loop avoidance, and policy implementation on the edge devices to decide which routes are installed in the local routing table of an edge device.

The overlay management protocols can advertise different types of routes, including OMP routes, TLOCs, and service routes. The OMP routes (or vRoutes) can include prefixes that establish reachability between end points that use the OMP-orchestrated transport network.

The OMP routes can represent services in a central data center, services at a branch office, or collections of hosts and other end points in any location of the overlay network. The OMP routes can use and resolve into TLOCs for functional forwarding. In comparison with BGP, an OMP route may be analogous to a prefix carried in any of the BGP AFI/SAFI fields. The transport locations (TLOCs) can include identifiers that tie an OMP route to a physical location.

The TLOC may be visible to the underlying network, and reachable via routing in the underlying network. A TLOC can be directly reachable through an entry in the routing table of the physical or underlay network, or it must be represented by a prefix residing on the outside of a NAT device and must be included in the routing table. In comparison with BGP, the TLOC acts as the next hop for OMP routes.

Service routes can include identifiers that tie an OMP route to a service in the network, specifying the location of the service in the network. Examples of services can include firewalls, Intrusion Detection Systems (IDPs), and load balancers (e.g., Layer 3 or Layer 4 services). Service route information can be carried in both service and OMP routes. However, traditional implementations of the service routes do not support the routing of applications implemented using resources available at specific edge devices, such as machine learning, video analytics, or other Layer 7 applications.

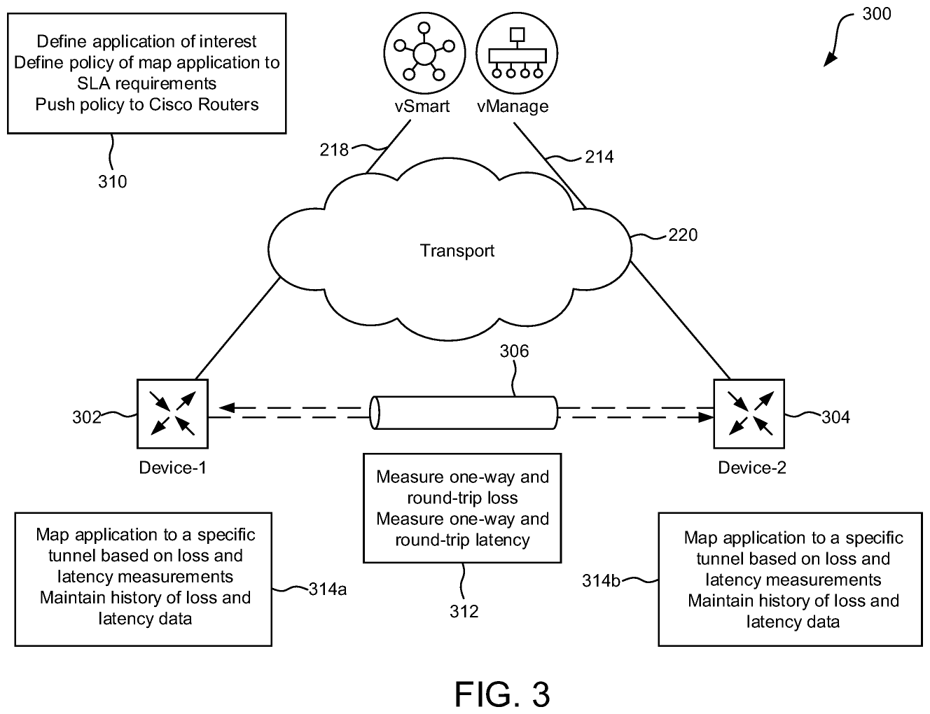

FIG. 3 illustrates a system 300 for application-aware routing, which can be implemented in overlay networks. In some examples, system 300 can include the network 200, or more generally, use the network architecture 100. Application-aware routing can track network and path characteristics of the data plane tunnels between the various edge devices 230 (e.g., vEdge routers) and use the collected information to compute optimal paths for data traffic in the transport network 200, for example. These characteristics can include packet loss, latency, jitter, load, cost, and/or bandwidth of a link or tunnel in the transport network 200. In some examples, an SDWAN application-aware routing mechanism such as the Cisco® SDWAN Application-Aware Routing solution can be implemented by the system 300. Such application-ware routing solution can include the functions identified in FIG. 3 as an identification function 310, monitoring and measuring functions 312, and mapping functions 314a-b. These functions are described further below, in an illustrative example of routing traffic between two edge devices 302 and 304 (which may be examples of the edge device 230) over a tunnel 306 (e.g., on the transport network 200) identified using the application-aware routing.

In some examples, the identification function 310 can include defining an application of interest and creating a centralized data policy that maps the application to a specific set of criteria such as Service Level Agreement (SLA) requirements. In an example, data traffic of interest can be particularly identified by matching Layer 3 and Layer 4 headers in packets of the data traffic. The matching can include source and destination prefixes and ports, protocols, Differentiated Services Code Point (DSCP) fields, etc. Centralized data policies for such matching and identification can be configured on a network controller 218 and then distributed to respective edge devices 230 (e.g., devices 302 and 304)

The monitoring and measuring functions 312 can include monitoring the data traffic on the data plane tunnels between the respective edge devices 302 and 304, and periodically measuring the performance characteristics of the tunnels, including the tunnel 306. For example, Cisco® SDWAN application software can use Bidirectional Forwarding Detection (BFD) packets to continuously monitor the data traffic on the data plane tunnels between the edge devices 302 and 304, and periodically measure the performance characteristics of the tunnel 306. To gauge performance, the monitoring and measuring systems can examine the tunnel to determine whether there has been any traffic loss on the tunnel, measure latency based on determining the one-way and round-trip times of traffic traveling over the tunnel, etc. These measurements can also indicate failure conditions, if any, such as a blackout or a brownout condition on the tunnel.

The mapping functions 314a-b can include mapping application traffic to a specific transport tunnel such as the tunnel 306. For example, an application's data traffic can be mapped to the data plane tunnel 306 that has been identified as providing the desired performance for the application based on the identification function 310 and the monitoring and measuring functions 312. The mapping functions 314a-b can be respectively implemented at both edge devices 302 and 304. The mapping functions 314a-b can perform the mapping based on criteria such as the best path for the traffic (e.g., computed from measurements performed on the WAN connections) and any constraints specified in a policy specific to the application-aware routing.

While the above description illustrates various aspects of managing and routing traffic in SDWANs, there may be additional systems for managing the operations at various sites which may be connected to an SDWAN. For example, the edge devices 230 connecting the various sites 232-238 to the transport network 220 can be configured with infrastructure for managing applications and resources at the sites. In some examples, hyper converged infrastructure (HCI) provides a flexible platform for storage, computation, and networking using software and hardware resources (e.g., servers) at the sites without relying on expensive, customized solutions. HCIs can decrease complexity and increase scalability at local or remote sites such as data centers and others.

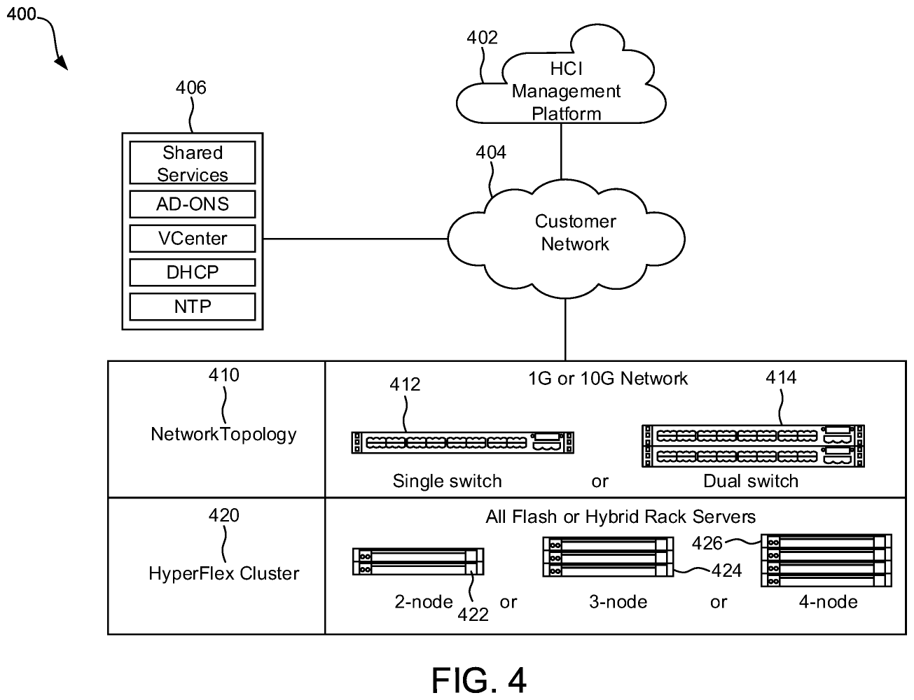

FIG. 4 illustrates an example of a system 400 for implementing a hyper converged infrastructure (HCI). In some examples, the system 400 can be deployed at a network device such as an edge device 230. An example HCI includes a Cisco® HyperFlex system configured on a Cisco® Uniform Computing System (UCS) platform. Such HCIs according to system 400 can be deployed in a time efficient manner and offer features of high flexibility, efficiency, and reduced risk to customers. For example, the system 400 can be configured for simplicity, agility, scalability, and support pay-as-you-grow economics offered by cloud-based systems. Benefits of using the system 400 also include multisite, distributed computing at global scale. In some examples, an HCI can be customized for edge devices, such as the Cisco® HyperFlex Edge which offers optimized solutions for remote sites, branch offices, and other edge environments/local sites.

For example, the system 400 can be managed using a cloud based management platform such as a Cisco® Intersight platform or HCI management platform 402, which will be explained in detail below. A customer network 404 at the cloud can include various functions and resources 406 such as shared services, Active Directory Domain Name System (DNS) servers, virtualization centers, Dynamic Host Configuration Protocol (DHCP), Network Time Protocol (NTP), or others. The customer network 404 can implement a network topology 410 which can include various types of switches such as single switches 412, dual switches 414, etc. An HCI system can be used for managing and operating the network 404. For example, a HyperFlex Cluster 420 created for the network topology using an HCI platform can include all flash or hybrid rack servers which include 2-nodes 422, 3-nodes 424, or 4-nodes 426.

In some examples, the HCI systems such as the customized Cisco HyperFlex Edge can also be implemented with a reduced form factor and offer features for next generation HCI platforms without requiring connections to compute systems such as the Cisco® UCS Fabric Interconnects. The HyperFlex Edge deployment at some edge nodes can be managed using a platform such as the Cisco® Intersight cloud management platform. A management controller such as the Cisco® Integrated Management Controller (CIMC) service can be executed within servers at the local cite, where the CIMC or other service can include baseboard management software to provide embedded server management for servers such as Cisco® UCS C-Series and HX-Series Rack Servers. The CIMC or other such service can be configured to operate in Dedicated Mode or Shared Mode, for example, where the Dedicated Mode may use a dedicated management port on a server's motherboard, while in the Shared Mode any LOM port or VIC adapter card port can be used to access the CIMC. In an illustrative example, a Cisco® HyperFlex Edge cluster requires a minimum of two HX-Series edge nodes, where the HX-Series edge nodes combine the CPU and RAM resources for hosting guest virtual machines with a shared pool of the physical storage resources used by a HX Data Platform software. HX-Series hybrid edge nodes use a combination of solid-state disks (SSDs) for caching and hard-disk drives (HDDs) for the capacity layer. HX-Series all-flash edge nodes use Serial-Attached Small Computer System Interface (SCSI) or “SAS” SSD for the caching layer and Serial Advanced Technology Attachment (SATA) SSDs for the capacity layer.

In some examples, a management platform such as the Cisco® Intersight can be used for the system 400. Such a platform can provide an API driven, cloud-based system management solution which may be used by organizations for implementing information technology (IT) management and operations with automation, simplicity, and operational efficiency. The management platform can be used by computing systems such as the Cisco® Unified Computing System (UCS) and the HCI systems such as the Cisco® HyperFlex systems to provide a holistic and unified management in distributed and virtualized environments. For example, the Cisco® Intersight can be used to improve efficiency and reduce complexity in the installation, monitoring, troubleshooting, upgrading and supporting infrastructure at the edge nodes and other network sites.

In some examples, the cloud based management offered by the management platform such as the Cisco® Intersight can support both the Cisco UCS and HyperFlex from the cloud, which can improve speed, simplicity, and scalability in the management of the infrastructure at sites such as datacenters, remote and branch office locations, etc. In some examples, the management platforms can also support automation using a unified API in the Cisco UCS and Cisco HyperFlex systems to enable policy driven configuration and management of the infrastructure, in turn enabling the network devices to be fully programmable. The platform can also offer analytics and telemetry support for monitoring the health and relationships of all the physical and virtual infrastructure components, and collect telemetry and configuration information for developing the intelligence of the platform in accordance with respective information security requirements.

In some examples, the management platforms can also enable integration with technical support such as the Cisco® Technical Assistance Center (TAC), thus improving efficiency, enabling proactive technical support, and enhanced operations automation by expediting sending files to speed troubleshooting. In some examples, the management platforms can include a recommendation engine, which can be driven by analytics and machine learning. For example, Cisco® Intersight includes a recommendation engine for providing actionable intelligence for IT operations management from an ever increasing knowledge base and practical insights learned in the entire system. Accordingly the management platforms such as the Cisco® Intersight can offer a cloud based management as a service to the various network devices in a scalable and easy to implement manner, without incurring the costs and burdens of maintaining systems management software and hardware at the data centers.

Although the SDWAN solutions described with reference to FIGS. 1-3 and the HCI systems and associated management platforms of FIG. 4 can be utilized by common nodes (e.g., edge devices), they are conventionally implemented as independent and separate systems. In example aspects of this disclosure, it is recognized that there are common resources and functions with respect to these independent systems which can be leveraged in integrated solutions. For example, integration of an HCI system and SDWAN solutions can provide a seamless deployment for the environment at an edge node and cloud based edge management. For example, a cloud based management platform such as the Cisco® Intersight can be used as a centralized dashboard to manage server resources at an edge node (e.g., a local site), the Software-Defined Data Platform, switch configuration, and the SDWAN configuration in a unified system. For example, a can:

In example aspects of this disclosure, an integrated management platform for a network device (e.g., an edge device) connected to an SDWAN is described. In some examples, the integrated management platform can include a cloud based management platform such as the Cisco® Intersight. The integrated management platform can be configured for automatically generating switch configuration for connecting the resources behind the edge device as well as for connections between the edge device and one or more other edge devices or control, management, or orchestration appliances using the SDWAN's transport network. In some examples, the integrated management platform can be automated for remote deployment of virtual routers and other Virtual Network Functions (VNFs). In some examples, automated deployment of VNFs can include SDWAN VNF deployment and bootstrapping thereof, deploying port groups for VNF connectivity, among others. The integrated management platform can also include various APIs, user interfaces, etc., which can enable functions such as view status and telemetry for the SDWAN and/or the resources of the edge device.

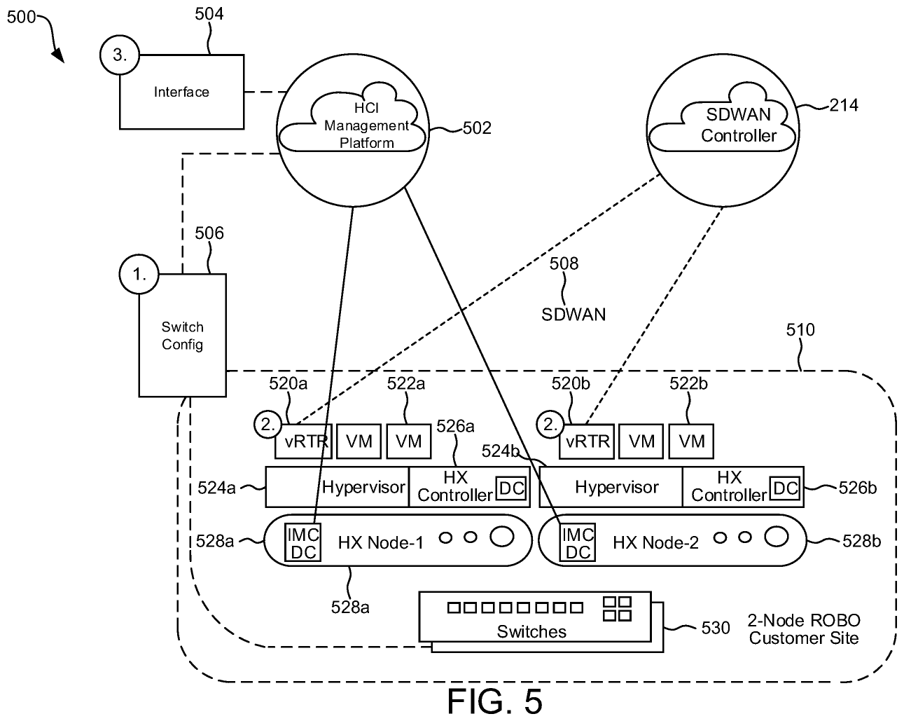

FIG. 5 illustrates an example system 500 which includes an integrated management platform according to aspects of this disclosure. The system 500 can be deployed at a local site 510 which can be remote site such as a 2 node ROBO customer site in an illustrative example. The local site can connect to a network fabric such as SDWAN 508 through one or more edge devices 520a-b (e.g., vEdge routers or VRTRs). The local site can include various resources behind the edge devices 520a-b, including respective sets of virtual machines (VMs) 522a-b, hyper converged (HX) controllers 524a-b, HX nodes 528a-b, among others. A network of switches 530 can support connectivity to various servers, computational resources, and other hardware which may be supported by the local site 510.

In some examples, an SDWAN network management system 214 such as a vManage NMS can be used for managing the network connections between the different edge devices 520a-b and other edge devices, network controllers, etc., connected to the SDWAN 508. In some examples, a management platform 502 such as a cloud based management platform (e.g., Cisco® Intersight) can be integrated into the local site 510 to provide an integrated solution for internal resource management as well as connectivity to the SDWAN 508. In an example, the management platform 502 can be configured for automatically generating a switch configuration 506 for connecting the resources behind the edge device, such as the switches 530 as well as for connections between the edge devices 520a-b and one or more other edge devices or control, management, or orchestration appliances over the SDWAN 508. Further, the integrated management platform can also support an API 504 and/or other user interfaces, etc., which can enable functions such as viewing status and telemetry for the SDWAN and/or the resources of the local site 510.

As previously mentioned, the traditional SDWAN service routes are currently limited to Layer 3 or Layer 4 services, but exclude Layer 7 applications. In example aspects, the integrated management platform 502 can be leveraged to support Layer-7 applications to be shared routes. In some examples, an application route can be provided on an SDWAN for sharing Layer-7 applications such as Hyper Converged Applications. The application routes can be separate from the traditional service routes and IP routes which may already exist in SDWAN deployments. For example, the Layer-7 application routes can be used for sharing applications across edge locations connected to the SDWAN 508. Sharing such Hyper Converged Applications over the SDWAN is also referred to as Hyper Converged Application chaining over the SDWAN.

In some examples, a dynamic Resource Availability Indicator (RAI) can be associated with Hyper Converged Applications, where the RAI can be used to advertise availability of such Applications on the SDWAN's control plane. The RAI can be configured to identify a Hyper Converged Application and indicate whether the Hyper Converged Application is available and sharable with the one or more network devices connected to the SDWAN. Such advertisements can be used by the one or more network devices at other SDWAN edge locations to route and share such Hyper Converged Applications. In some examples, the Hyper Converged Applications can include compute-heavy and/or storage-heavy applications running on a local site, where sharing the applications over the SDWAN 508 with other edge devices can distribute the benefits of the applications without substantial increase in costs and redundant resources.

For example, the local site 510 can be deployed at a large store location of a retail chain. The local site 510 can include resource support for a Hyper Converged Machine Learning based Video Analytics application to be deployed at the local site. In example aspects, the edge devices 520a and/or 520b can advertise the availability of the Machine Learning or Video Analytics capability over SDWAN 508 to be distributed over the Application Routes. The advertisements can include the Resource Availability Indicators associated with the Hyper Converged Applications. This advertisement can enable other store locations of the retail chain to learn about the capability (pertaining to the Hyper Converged Applications) of the local site 510 and leverage these Hyper Converged Applications, e.g., in an on-demand manner without having to deploy the resources at their sites. In this manner, the various store locations can utilize the compute/storage intensive applications over the SDWAN 508 without incurring the costs to deploy them at their local sites. The cloud based management platform 502 can provide analytics, telemetry, etc., to the various locations using the API 504.

In some examples, if two or more store locations advertise the same Application over the SDWAN 508, a store location of the two or more store locations with better resource availability (e.g., in terms of computation, storage, input/output port capacity, etc.,) can be selected by the management platform 502 (or by the NMS 214), which can distribute the load in a more balanced manner and avoid overloading a single store location's resources from multiple demands. The management platform 502 and/or the NMS 214 can monitor the resource availabilities of the various store locations. The various store locations can also monitor the SDWAN 508 for advertisements of the Hyper Converged Applications. Such monitoring can be event-based or streaming-based, depending on configuration. In this manner, the availability of Hyper Converged Applications can be expanded and made available to several sites without restricting their availability to deployments behind edge nodes 520a-b of the local site 510, for example.

While a network administrator may have visibility into Applications which can be shared on an SDWAN, identify the Applications, define path control for the identified Applications, and set policy/thresholds to route these Applications (e.g., based on characteristics of underlying WAN links), these functions performed by the network administrator may be manual, time consuming and lack scalability in existing implementations. Furthermore visibility for an Application may also be manually enabled and then policies may be specified by the network administrator accordingly. Thus, with a growing number of applications, including the addition of Hyper Converged Applications on Layer 7 as mentioned above, it is not practical, efficient, economical, or scalable for a network administrator to manually perform such functions for each instance of an Application being introduced on an SDWAN, to classify the correctly the Application correctly (e.g., in terms of Quality of Service or QoS) and route the Application over the optimum set of WAN links to meet performance criteria.

Accordingly, example aspects of this disclosure also include automated SDWAN policies for Applications deployed on an HCI, for example, using the integrated platform of system 500. In some examples, a Hyper Convergence Controller (e.g., HX controllers 526a-b) at a local site 510 can spin up or instantiate Hyper Convergence Applications at the local site 510, e.g., at HX node clusters 528a-b behind the SDWAN routers or edge devices 520a-b. Once the Application is instantiated and deployed at the local site 510, for example, the Application can be automatically identified by the HX controller or the management platform 502 (e.g., Cisco® Intersight). In an example, the Application can be identified as a custom Application with related metrics of expected delay, latency, QoS settings, etc., by the HX controller.

The HX controllers 526a-b can use APIs to communicate with the SDWAN network controller or NMS 214 (e.g., Cisco® vManage) and inform the controller that the newly instantiated Application is available to be advertised and shared on the SDWAN 508.

The HX controllers 526a-b and/or the management platform 502 can also request policy settings for the newly instantiated Application from the SDWAN network controller or NMS 214. Accordingly, the HX controllers 526a-b can provide a request for self-identification or auto-identification of the newly instantiated Application. The HX controllers 526a-b can also provide recommended policy settings and SLA (e.g., via APIs) to the SDWAN network controller or NMS 214.

In some examples, the SDWAN network controller or NMS 214 can be configured to accept or reject the proposed auto-identification. If the SDWAN network controller rejects the auto-identification request, the SDWAN network controller may manually configure the policy settings for the newly instantiated Application. On the other hand, if the SDWAN network controller (or a network administrator) accepts the recommended settings, policy generation for the Application can be automated at the SDWAN Controller and the generated policies can be pushed to the SDWAN control plane as new Applications are spun up or instantiated at HX nodes at edge devices.

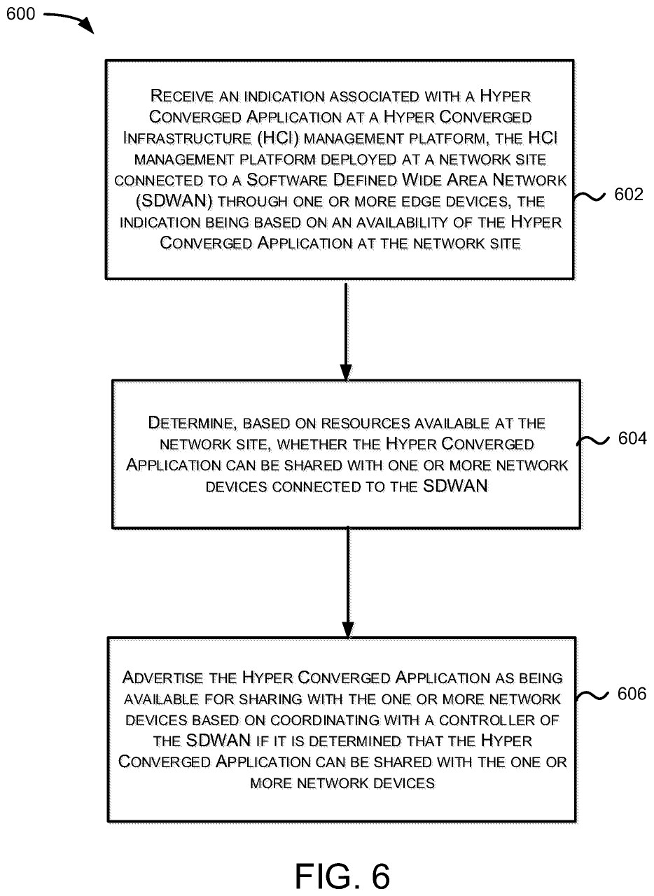

Having described example systems and concepts, the disclosure now turns to the process 600 illustrated in FIG. 6. The blocks outlined herein are examples and can be implemented in any combination thereof, including combinations that exclude, add, or modify certain steps.

At the block 602, the process 600 includes receiving an indication associated with a Hyper Converged Application at a Hyper Converged Infrastructure (HCI) management platform, the HCI management platform deployed at a network site connected to a Software Defined Wide Area Network (SDWAN) through one or more edge devices, the indication being based on an availability of the Hyper Converged Application at the network site. For example, the management platform 502 deployed at the local site 510 can receive an indication such as a Resource Availability Indicator associated with a Hyper Converged Application deployed at the local site 510, where the local site is connected to the SDWAN 508 through one or more edge devices. In some examples, the indication can be based on an availability of the Hyper Converged Application at the local site 510. For example, the indication can include the Resource Availability Indicator (RAI) advertised by a Hyper Converged Application controller of the network site based on the Hyper Converged Application being instantiated at the network site, where the RAI is configured to identify the Hyper Converged Application and indicate whether the Hyper Converged Application is available and sharable with the one or more network devices connected to the SDWAN

At the block 604, the process 600 includes determining, based on resources available at the network site, whether the Hyper Converged Application can be shared with one or more network devices connected to the SDWAN. For example, determining whether the Hyper Converged Application can be shared with one or more network devices can be based on comparing resources available at two or more network sites advertising the Hyper Converged Application. For example, if there are two or more locations of a retail chain which advertise the same Hyper Converged Machine Learning based Video Analytics application, the HCI management platform and/or the SDWAN controller (e.g., the NMS 214 or Cisco® vManage) can determine, based on resource availability in terms of storage, computational capacity, etc., at the two or more locations, which location's Application may be shared.

At the block 606, the process 600 includes advertising the Hyper Converged Application as being available for sharing with the one or more network devices based on coordinating with a controller of the SDWAN if it is determined that the Hyper Converged Application can be shared with the one or more network devices. In some examples, application chaining using the SDWAN control plane can be used for advertising and sharing the Hyper Converged Applications.

In some examples, the HCI management platform can include the Cisco® Intersight or another cloud based Hyper Converged Infrastructure management platform for one or more of automated generation of switch configuration (e.g., switch configuration 506) of resources at the local site 510, automated deployment of Virtual Network Functions (VNFs), or generation of status and telemetry pertaining to the SDWAN to be provided over one or more user interfaces (e.g., using the interface 504). In some examples, automated deployment of VNFs can include SDWAN VNF deployment and bootstrapping thereof, deploying port groups for VNF connectivity, among others.

In some examples, the Hyper Converged Application can include one or more Layer 7 applications sharable over an application route of the SDWAN with the one or more network devices. The application routes can be separate from the traditional service routes and IP routes which may already exist in SDWAN deployments. In some examples, policies can be automatically received and deployed for the Hyper Converged Application upon their instantiation. For example, the HCI management platform 502 can receive one or more parameters related to the Hyper Converged Application from the Hyper Converged Application controller (e.g., HX controllers 526a-b), the one or more parameters comprising one or more of an expected delay, latency, or Quality of Service (QoS) settings related to the Hyper Converged Application. The HCI management platform 502 or the edge devices 520a-b can communicate a request for policy settings for the Hyper Converged Application, the one or more parameters, and one or more recommendations for policy settings for the Hyper Converged Application to the SDWAN network controller or NMS 214, and receive policy settings in response to the request, based on the request being accepted by the SDWAN controller. The HX controllers 526a-b can provide the policy settings to the Hyper Converged Application controller for the policy settings to be applied to the Hyper Converged Application

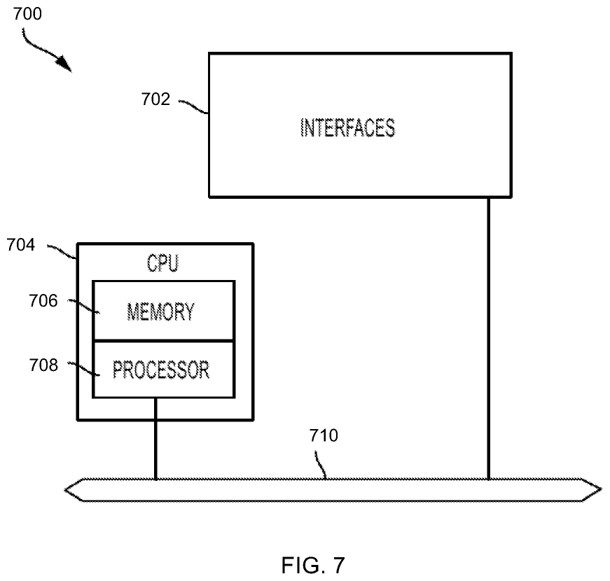

FIG. 7 illustrates an example network device 700 suitable for implementing the aspects according to this disclosure. In some examples, the edge devices, HCI controllers, SDWAN controllers, and other network devices described herein may be implemented according to the configuration of the network device 700. The network device 700 includes a central processing unit (CPU) 704, interfaces 702, and a connection 710 (e.g., a PCI bus). When acting under the control of appropriate software or firmware, the CPU 704 is responsible for executing packet management, error detection, and/or routing functions. The CPU 704 preferably accomplishes all these functions under the control of software including an operating system and any appropriate applications software. The CPU 704 may include one or more processors 708, such as a processor from the INTEL X86 family of microprocessors. In some cases, processor 708 can be specially designed hardware for controlling the operations of the network device 700. In some cases, a memory 706 (e.g., non-volatile RAM, ROM, etc.) also forms part of the CPU 704. However, there are many different ways in which memory could be coupled to the system.

The interfaces 702 are typically provided as modular interface cards (sometimes referred to as “line cards”). Generally, they control the sending and receiving of data packets over the network and sometimes support other peripherals used with the network device 700. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces, WIFI interfaces, 3G/4G/5G cellular interfaces, CAN BUS, LoRA, and the like. Generally, these interfaces may include ports appropriate for communication with the appropriate media. In some cases, they may also include an independent processor and, in some instances, volatile RAM. The independent processors may control such communications intensive tasks as packet switching, media control, signal processing, crypto processing, and management. By providing separate processors for the communications intensive tasks, these interfaces allow the CPU 704 to efficiently perform routing computations, network diagnostics, security functions, etc.

Although the system shown in FIG. 7 is one specific network device of the present technologies, it is by no means the only network device architecture on which the present technologies can be implemented. For example, an architecture having a single processor that handles communications as well as routing computations, etc., is often used. Further, other types of interfaces and media could also be used with the network device 700.

Regardless of the network device's configuration, it may employ one or more memories or memory modules (including memory 706) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc. The memory 706 could also hold various software containers and virtualized execution environments and data.

The network device 700 can also include an application-specific integrated circuit (ASIC), which can be configured to perform routing and/or switching operations. The ASIC can communicate with other components in the network device 700 via the connection 710, to exchange data and signals and coordinate various types of operations by the network device 700, such as routing, switching, and/or data storage operations, for example.

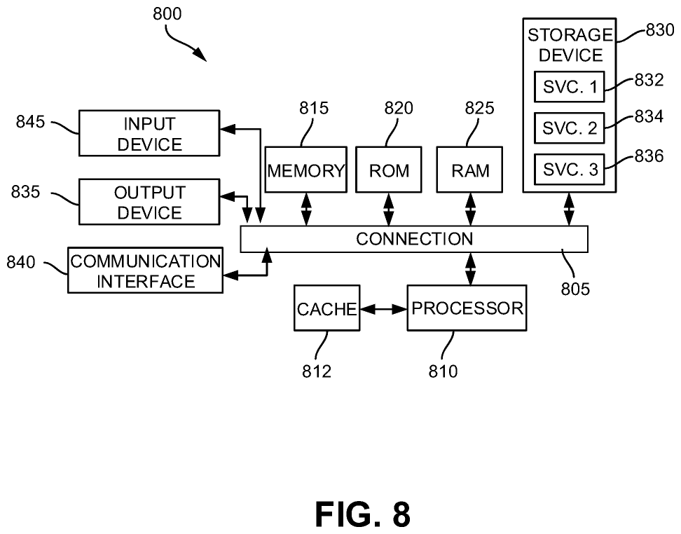

FIG. 8 illustrates an example computing device architecture 800 of an example computing device which can implement the various techniques described herein. The components of the computing device architecture 800 are shown in electrical communication with each other using a connection 805, such as a bus. The example computing device architecture 800 includes a processing unit (CPU or processor) 810 and a computing device connection 805 that couples various computing device components including the computing device memory 815, such as read only memory (ROM) 820 and random access memory (RAM) 825, to the processor 810.

The computing device architecture 800 can include a cache of high-speed memory connected directly with, in close proximity to, or integrated as part of the processor 810. The computing device architecture 800 can copy data from the memory 815 and/or the storage device 830 to the cache 812 for quick access by the processor 810. In this way, the cache can provide a performance boost that avoids processor 810 delays while waiting for data. These and other modules can control or be configured to control the processor 810 to perform various actions. Other computing device memory 815 may be available for use as well. The memory 815 can include multiple different types of memory with different performance characteristics. The processor 810 can include any general purpose processor and a hardware or software service, such as service 1 832, service 2 834, and service 3 836 stored in storage device 830, configured to control the processor 810 as well as a special-purpose processor where software instructions are incorporated into the processor design. The processor 810 may be a self-contained system, containing multiple cores or processors, a bus, memory controller, cache, etc. A multi-core processor may be symmetric or asymmetric.

To enable user interaction with the computing device architecture 800, an input device 845 can represent any number of input mechanisms, such as a microphone for speech, a touch-sensitive screen for gesture or graphical input, keyboard, mouse, motion input, speech and so forth. An output device 835 can also be one or more of a number of output mechanisms known to those of skill in the art, such as a display, projector, television, speaker device, etc. In some instances, multimodal computing devices can enable a user to provide multiple types of input to communicate with the computing device architecture 800. The communications interface 840 can generally govern and manage the user input and computing device output. There is no restriction on operating on any particular hardware arrangement and therefore the basic features here may easily be substituted for improved hardware or firmware arrangements as they are developed.

Storage device 830 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 825, read only memory (ROM) 820, and hybrids thereof. The storage device 830 can include services 832, 834, 836 for controlling the processor 810. Other hardware or software modules are contemplated. The storage device 830 can be connected to the computing device connection 805. In one aspect, a hardware module that performs a particular function can include the software component stored in a computer-readable medium in connection with the necessary hardware components, such as the processor 810, connection 805, output device 835, and so forth, to carry out the function.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Some examples of such form factors include general purpose computing devices such as servers, rack mount devices, desktop computers, laptop computers, and so on, or general purpose mobile computing devices, such as tablet computers, smart phones, personal digital assistants, wearable devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” a set indicates that one member of the set or multiple members of the set satisfy the claim. For example, claim language reciting “at least one of A and B” means A, B, or A and B.

1. A method comprising:
receiving an indication associated with a Hyper Converged Application at a Hyper Converged Infrastructure (HCI) management platform, the HCI management platform deployed at a network site connected to a Software Defined Wide Area Network (SDWAN) through one or more edge devices, the indication being based on an availability of the Hyper Converged Application at the network site;
determining, based on resources available at the network site, whether the Hyper Converged Application can be shared with one or more network devices connected to the SDWAN; and
based on a determination that the Hyper Converged Application can be shared with the one or more network devices, coordinating, with a controller of the SDWAN, an advertisement of the Hyper Converged Application and an associated Layer 7 application route transmitted via an SDWAN control plane, the advertisement indicating that the Hyper Converged Application is available for sharing with the one or more network devices.

2. The method of claim 1, wherein the HCI management platform comprises a cloud based management platform for one or more of automated generation of switch configuration of resources at the network site, automated deployment of Virtual Network Functions (VNFs), or generation of status and telemetry pertaining to the SDWAN to be provided over one or more user interfaces.

3. The method of claim 1, wherein the Hyper Converged Application comprises one or more Layer 7 applications sharable over the associated Layer 7 application route with the one or more network devices.

4. The method of claim 1, wherein determining whether the Hyper Converged Application can be shared with one or more network devices comprises comparing resources available at two or more network sites hosting instances of the Hyper Converged Application.

5. The method of claim 1, wherein the indication comprises a Resource Availability Indicator (RAI) advertised by a Hyper Converged Application controller of the network site based on the Hyper Converged Application being instantiated at the network site, the RAI configured to identify the Hyper Converged Application and indicate whether the Hyper Converged Application is available and sharable with the one or more network devices connected to the SDWAN.

6. The method of claim 5, further comprising:
receiving one or more parameters related to the Hyper Converged Application from the Hyper Converged Application controller, the one or more parameters comprising one or more of an expected delay, latency, or Quality of Service (QoS) settings related to the Hyper Converged Application.

7. The method of claim 6, further comprising:
communicating a request for policy settings for the Hyper Converged Application, the one or more parameters, and one or more recommendations for policy settings for the Hyper Converged Application to the controller of the SDWAN.

8. The method of claim 7, further comprising:
receiving policy settings in response to the request, based on the request being accepted by the controller of the SDWAN, and providing the policy settings to the Hyper Converged Application controller for the policy settings to be applied to the Hyper Converged Application.

9. A system, comprising:
one or more processors; and
a non-transitory computer-readable storage medium containing instructions which, when executed on the one or more processors, cause the one or more processors to perform operations including:
receiving an indication associated with a Hyper Converged Application at a Hyper Converged Infrastructure (HCI) management platform, the HCI management platform deployed at a network site connected to a Software Defined Wide Area Network (SDWAN) through one or more edge devices, the indication being based on an availability of the Hyper Converged Application at the network site;
determining, based on resources available at the network site whether the Hyper Converged Application can be shared with one or more network devices connected to the SDWAN; and
based on a determination that the Hyper Converged Application can be shared with the one or more network devices, coordinating with a controller of the SDWAN, an advertisement of the Hyper Converged Application and an associated Layer 7 application route transmitted via an SDWAN control plane, the advertisement indicating that the Hyper Converged Application is available for sharing with the one or more network devices.

10. The system of claim 9, wherein the HCI management platform comprises a cloud based management platform for one or more of automated generation of switch configuration of resources at the network site, automated deployment of Virtual Network Functions (VNFs), or generation of status and telemetry pertaining to the SDWAN to be provided over one or more user interfaces.

11. The system of claim 9, wherein the Hyper Converged Application comprises one or more Layer 7 applications sharable over the associated Layer 7 application route with the one or more network devices.

12. The system of claim 9, wherein determining whether the Hyper Converged Application can be shared with one or more network devices comprises comparing resources available at two or more network sites hosting instances of the Hyper Converged Application.

13. The system of claim 9, wherein the indication comprises a Resource Availability Indicator (RAI) advertised by a Hyper Converged Application controller of the network site based on the Hyper Converged Application being instantiated at the network site, the RAI configured to identify the Hyper Converged Application and indicate whether the Hyper Converged Application is available and sharable with the one or more network devices connected to the SDWAN.

14. The system of claim 13, wherein the operations further comprise:
receiving one or more parameters related to the Hyper Converged Application from the Hyper Converged Application controller, the one or more parameters comprising one or more of an expected delay, latency, or Quality of Service (QoS) settings related to the Hyper Converged Application.

15. The system of claim 14, wherein the operations further comprise:
communicating a request for policy settings for the Hyper Converged Application, the one or more parameters, and one or more recommendations for policy settings for the Hyper Converged Application to the controller of the SDWAN.

16. The system of claim 15, wherein the operations further comprise:
receiving policy settings in response to the request, based on the request being accepted by the controller of the SDWAN, and providing the policy settings to the Hyper Converged Application controller for the policy settings to be applied to the Hyper Converged Application.

17. A non-transitory machine-readable storage medium, including instructions configured to cause a data processing apparatus to perform operations including:
receiving an indication associated with a Hyper Converged Application at a Hyper Converged Infrastructure (HCI) management platform, the HCI management platform deployed at a network site connected to a Software Defined Wide Area Network (SDWAN) through one or more edge devices, the indication being based on an availability of the Hyper Converged Application at the network site;
determining, based on resources available at the network site whether the Hyper Converged Application can be shared with one or more network devices connected to the SDWAN; and
based on a determination that the Hyper Converged Application can be shared with the one or more network devices, coordinating, with a controller of the SDWAN, an advertisement of the Hyper Converged Application and an associated Layer 7 application route transmitted via an SDWAN control plane, the advertisement indicating that the Hyper Converged Application is available for sharing with the one or more network devices.

18. The non-transitory machine-readable storage medium of claim 17, wherein the HCI management platform comprises a cloud based management platform for one or more of automated generation of switch configuration of resources at the network site, automated deployment of Virtual Network Functions (VNFs), or generation of status and telemetry pertaining to the SDWAN to be provided over one or more user interfaces.

19. The non-transitory machine-readable storage medium of claim 17, wherein the Hyper Converged Application comprises one or more Layer 7 applications sharable over the associated Layer 7 application route with the one or more network devices.

20. The non-transitory machine-readable storage medium of claim 17, wherein determining whether the Hyper Converged Application can be shared with one or more network devices comprises comparing resources available at two or more network sites hosting instances of the Hyper Converged Application.
